(19) United States
(12) Patent Application Publication
(10) Pub. No.: US 2020/0371614 A1
(43) Pub. Date: Nov. 26, 2020

(54) TOUCH SCREEN PANEL AND MANUFACTURING METHOD THEREFOR

(71) Applicant: LG ELECTRONICS INC., Seoul (KR)

(72) Inventor: Yangwook HUR, Seoul (KR)

(73) Assignee: LG Electronics Inc., Seoul (KR)

(21) Appl. No.: 16/633,417

(22) PCT Filed: Jan. 22, 2018
(86) PCT No.: PCT/KR2018/000928

§ 371 Date: Jan. 23, 2020

(30) Foreign Application Priority Data
Jul. 24, 2017 (KR) 10-2017-0093727

(51) Int. Cl. G06F 3/041

(52) U.S. Cl. CPC G06F 3/041; G06F 2203/04103

(57) ABSTRACT

The present disclosure relates to a touch screen panel including a silver nano-electrode and a manufacturing method therefor. The present disclosure provides a touch panel including a transparent substrate, a first pattern electrode formed on the transparent substrate and having a line width of 0.5 to 2.0 μm and a thickness of 0.1 to 1.0 μm, and a second pattern electrode arranged on an edge of the transparent substrate so as to be electrically connected to the first pattern electrode, and having a line width of 10 to 15 μm, wherein the first and second pattern electrodes include nano-particles having an average particle diameter of 10 to 20 nm. The line width of the pattern electrode formed on the touch screen panel, according to the present disclosure, is at least 1.5 times thinner than that of a related art technology, thereby minimizing a moire phenomenon occurring in the touch screen panel. Therefore, the present disclosure may improve visibility of the touch screen panel.

### TECHNICAL FIELD

The present disclosure relates to a touch screen panel including a silver nano-electrode and a method for manufacturing the same.

### BACKGROUND ART

A touch screen panel is a plate used to operate a computing device with a touch of a finger. The touch screen panel requires two layers of sensor (ITO) to recognize a position of a finger on the screen. The ITO sensor is implemented by depositing it on glass or printing on a film. A product that integrates a sensor on a display or a cover, not with a film attaching manner, is called an integrated touch screen panel. A cover integrated touch is classified into G2, G1, and others according to a number of sensor layers.

As illustrated in FIG. 1, a touch screen panel 110a may be formed on a display 110 of a mobile terminal 100. On the touch screen panel, an electrode overlapping the display is inevitably formed to sense a touch, and the electrode hides screen information displayed on the display, thereby degrading a quality of an image on the display. In particular, an electrode with a specific pattern causes a pattern due to moire phenomenon, and this may give users a sense of heterogeneity.

In the related art, a line width of an electrode formed in the touch screen panel is about several micrometers. In the line width, the electrode may adversely affect a quality of a displayed image, but it is difficult to form the line width thinner than the above-mentioned thickness.

On the other hand, a separate electrode to connect an external power source with the above-mentioned electrode is formed on an edge of the touch screen panel, and as the thickness of the electrode becomes thinner, a bezel portion of the touch screen panel may become thinner.

### DETAILED DESCRIPTION OF THE DISCLOSURE

### Technical Problem

An aspect of the present disclosure is to increase a visibility of a touch screen panel by reducing a line width of a pattern electrode formed on the touch screen panel to sense a touch.

In addition, an aspect of the present disclosure is to minimize an amount of raw materials consumed when forming the pattern electrode on the touch screen panel.

Also, an aspect of the present disclosure is to simplify a manufacturing process of the touch screen panel.

### Technical Solution

To achieve the aspects and other advantages of the present disclosure, there is provided a touch panel including a transparent substrate, a first pattern electrode formed on the transparent substrate and having a line width of 0.5 to 2.0 μm and a thickness of 0.1 to 1.0 μm, and a second pattern electrode arranged on an edge of the transparent substrate so as to be electrically connected to the first pattern electrode, and having a line width of 10 to 15 μm, wherein the first and second pattern electrodes include nano-particles having an average particle diameter of 10 to 20 nm.

In an embodiment, a light transmittance of a partial area of the transparent substrate on which the first pattern electrode is formed may be of 89.7 to 90.7%.

In an embodiment, a sheet resistance of the first pattern electrode may be of 100 to 336 Ω/sq.

In an embodiment, the second pattern electrode may comprise a plurality of line electrodes, and a distance between the line electrodes may be of 10 to 15 μm.

In an embodiment, a black layer deposited on the first pattern electrode may be further included.

In an embodiment, a thickness of the black layer may be of 26.8 to 53.2 nm.

In an embodiment, an insulating layer deposited on the black layer and made of a light-transmissive material may be further included.

In an embodiment, a thickness of the insulating layer may be of 73.7 to 146.3 nm.

The present disclosure also provides a method for manufacturing the touch screen panel including forming a fluorine-based polymer layer on a transparent substrate, irradiating light of a predetermined wavelength after overlapping a glass mask with a predetermined pattern formed on the transparent substrate, applying silver nano-particle ink so that silver nano-particles are adhered to a partial area of the transparent substrate to which the light of the predetermined wavelength is irradiated, and heating the transparent substrate to form a first pattern electrode and a second pattern electrode on the transparent substrate.

In an embodiment, a surface tension of the fluorine-based polymer layer before irradiating the light of the predetermined wavelength may be of 20 dynes or less, and the surface tension of the fluorine-based polymer layer after irradiating the light of the predetermined wavelength may be of 32 dynes or more.

### Advantageous Effects

The line width of the pattern electrode formed on the touch screen panel, according to the present disclosure, is at least 1.5 times thinner than that of the related art technology, thereby minimizing a moire phenomenon occurring in the touch screen panel. Therefore, the present disclosure may improve visibility of the touch screen panel.

Also, according to the present disclosure, since ink to form the pattern electrode may be selectively adhered on a transparent substrate, an amount of the ink may be minimized in forming the pattern electrode.

In addition, according to the present disclosure, since the pattern electrode and an electrode to connect an external power source to the pattern electrode may be formed simultaneously, a manufacturing process of the touch screen panel may be simplified.

### BRIEF DESCRIPTION OF THE DRAWINGS

FIG. 1 is a perspective view illustrating a mobile terminal.

FIG. 2 is a perspective view illustrating a touch screen panel.

FIG. 3 is an enlarged view of an area A in FIG. 2.

FIG. 4 is an SEM image of a pattern electrode illustrated in FIG. 3.

FIGS. 5A to 5C are SEM images of a pattern electrode on which a black layer is formed.

FIGS. 6A and 6B are SEM images of a pattern electrode on which an insulating layer is formed.

FIG. 7 is an enlarged view of an area B in FIG. 2.

FIGS. 8, 9A and 9B are SEM images of the electrode illustrated in FIG. 7.

### MODES FOR CARRYING OUT PREFERRED EMBODIMENTS

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In describing the present disclosure, if a detailed explanation for a related known function or construction is considered to unnecessarily divert the gist of the present disclosure, such explanation has been omitted but would be understood by those skilled in the art. The accompanying drawings are used to help easily understand the technical idea of the present disclosure and it should be understood that the idea of the present disclosure is not limited by the accompanying drawings. The idea of the present disclosure should be construed to extend to any alterations, equivalents and substitutes besides the accompanying drawings.

It will be understood that although the terms first, second, etc. may be used herein to describe various elements, these elements should not be limited by these terms. These terms are generally only used to distinguish one element from another.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

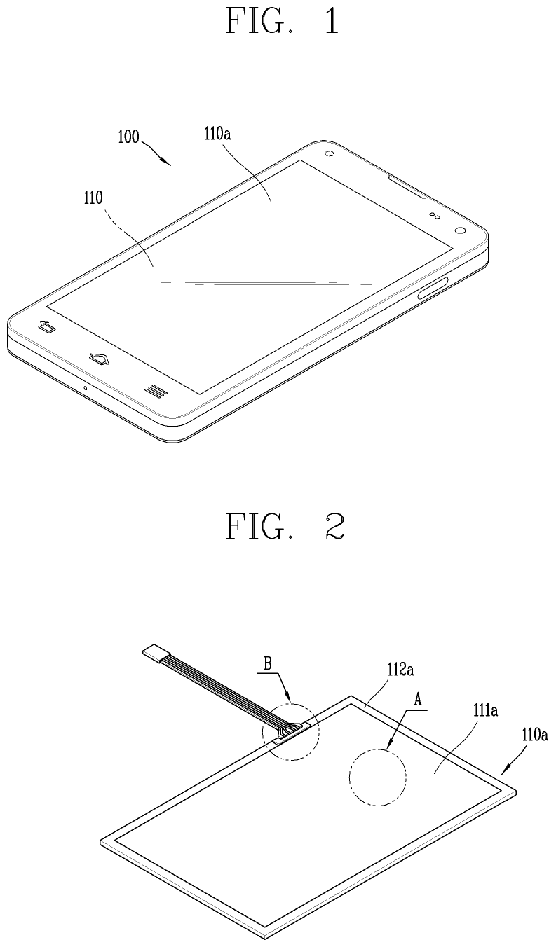

A touch screen panel according to the present disclosure may be utilized for a mobile terminal described in FIG. 1. As illustrated in FIG. 2, the touch screen panel according to the present disclosure includes a transparent substrate, and a first pattern electrode and a second pattern electrode formed on the transparent substrate. Here, the transparent substrate and the first pattern electrode are formed on an area 111a overlapping a display, and the second pattern electrode is formed on a bezel portion 112a. Hereinafter, the components will be described in detail.

FIG. 3 is an enlarged view of an area A in FIG. 2.

The transparent substrate is made of a light-transmissive material. For example, the transparent substrate may be made of a polymer material or made of glass. However, the present disclosure is not limited thereto, and the transparent substrate may be any material capable of fixing the pattern electrode, which will be described later, without hiding screen information output from the display.

Referring to FIG. 3, the first pattern electrode is formed on the transparent substrate to sense a touch input of a user. That is, the first pattern electrode is an electrode overlapping the display. Here, the first pattern electrode may have a line width of 0.5 to 2.0 μm and a thickness of 0.1 to 1.0 μm.

On the other hand, the first pattern electrode may be made of silver nano-particles, and an average particle diameter of the silver nano-particles may be of 10 to 20 nm. Here, when the average particle diameter of the silver nano-particles is less than 10 nm, colors of the silver nano-particles may change to affect a light transmittance of the touch screen panel. Meanwhile, when the average particle diameter of the silver nano-particles is more than 20 nm, the line width and the pattern electrode may be excessively thick.

The light transmittance of a partial area of the transparent substrate on which the first pattern electrode is formed is preferably 89.7% or more. The higher the light transmittance of the partial area of the transparent substrate on which the first pattern electrode is formed is, the better it is. However, when the line width of the first pattern electrode was of 0.5 to 2.0 μm, a minimum light transmittance was of 89.7%.

Meanwhile, a sheet resistance of the first pattern electrode may be of 100 to 336 Ω/sq. When the sheet resistance is less than 100 Ω/sq, a surface of the touch screen panel becomes sensitive to an electrical signal, thereby increasing a possibility of malfunction. And, when the sheet resistance exceeds 336 Ω/sq, a response speed to a touch of a user may become slower. Therefore, the sheet resistance of the first pattern electrode is preferably of 100 to 336 Ω/sq.

On the other hand, since the first pattern electrode is made of silver having a high reflectance, visibility of the touch screen panel may be inferior due to regular reflection in the first pattern electrode. In order to prevent this, a black layer may be formed on the first pattern electrode.

The black layer is a layer deposited on the first pattern electrode, and may be made of one of carbon black, silver oxide, and silver chloride. However, the present disclosure is not limited thereto, and the black layer may be formed of a material having a low reflectance.

On the other hand, a thickness of the black layer may be of 26.8 to 53.2 nm. When the thickness of the black layer is less than 26.8 nm, it is difficult to suppress a reflection of the first pattern electrode. However, since the black layer may sufficiently suppress the reflection of the first pattern electrode with a thickness of 26.8 to 53.2 nm, the black layer needs not to be formed with a thickness greater than 53.2 nm.

Meanwhile, an insulating layer may be formed on the black layer to perform an insulating function between the first pattern electrode and other layers forming the touch screen panel.

Here, the insulating layer may be made of a light-transmissive material. For example, the insulating layer may be made of at least one of acrylic, urethane, alkyl thiol, and silicon composite.

Meanwhile, a thickness of the insulating layer may be of 73.7 to 146.3 nm. When the thickness of the insulating layer is less than 73.7 nm, the insulating layer may not perform a sufficient insulating function. And, when the thickness of the insulating layer exceeds 146.3 nm, the touch screen panel may be excessively thick.

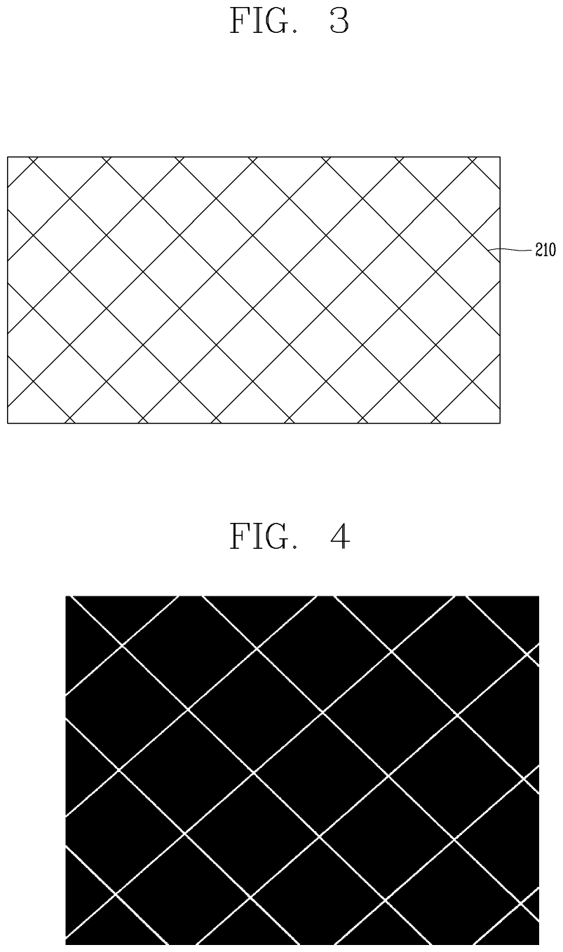

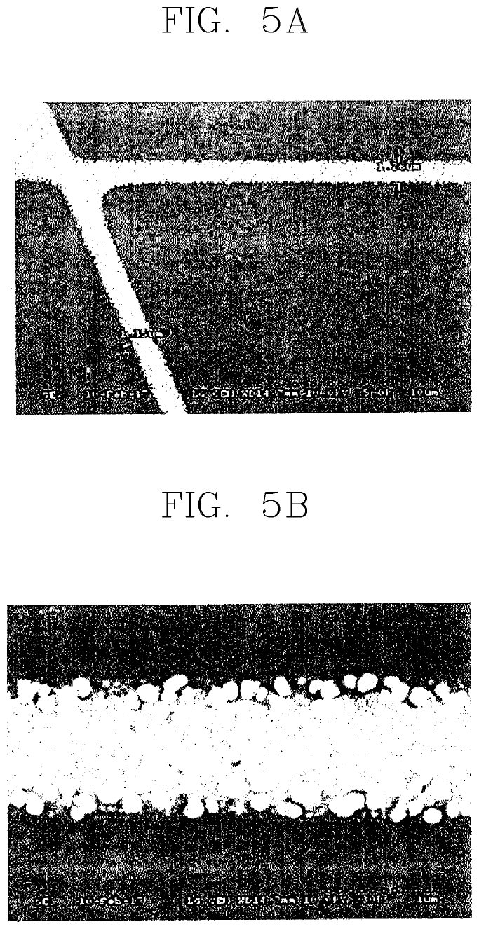

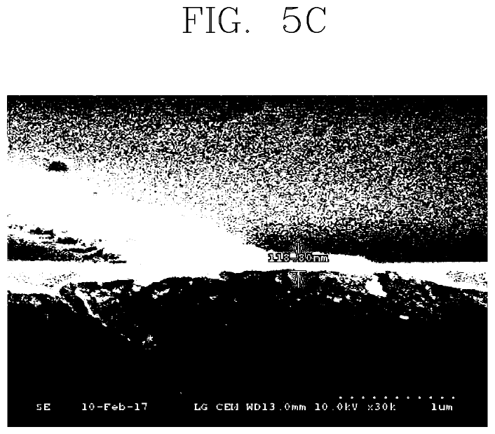

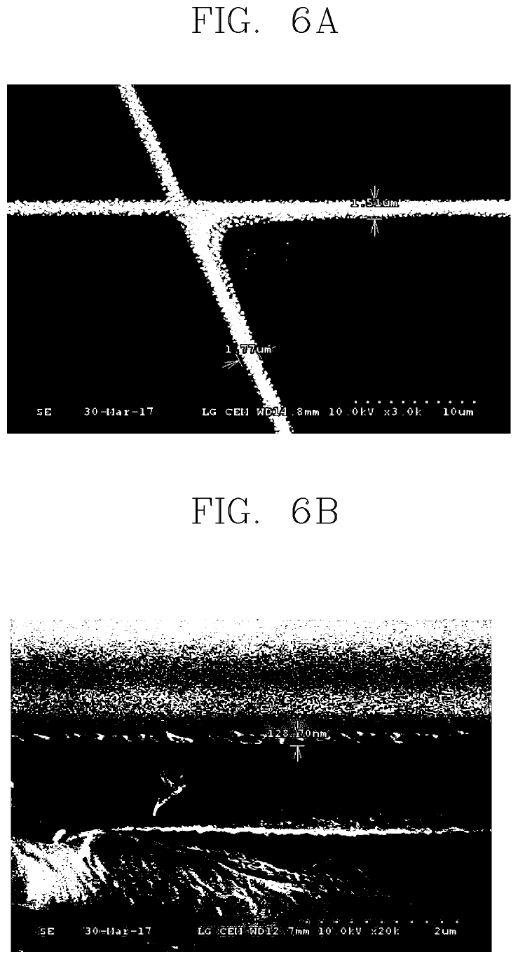

FIG. 4 is an SEM image of the pattern electrode illustrated in FIG. 3, FIGS. 5A to 5C are SEM images of the pattern electrode on which the black layer is formed, and FIGS. 6A and 6B are SEM images of the pattern electrode on which the insulating layer is formed.

Referring to FIG. 4, the first pattern electrode is formed with a predetermined pattern on the transparent substrate.

Meanwhile, FIGS. 5A and 5B are enlarged images of FIG. 4. in which the first pattern electrode on which the black layer is formed is illustrated, wherein white particles are the black layer and gray particles are the first pattern electrode. According to the drawing, the line width of the first pattern electrode is uniformly formed of 1.26 to 1.36 μm.

FIG. 5C is a cross-sectional view of the first pattern electrode illustrated in FIGS. 5A and 5B. Referring to FIG. 5C, the black layer is formed on the first pattern electrode.

FIG. 6A is an enlarged image of FIG. 4. in which the first pattern electrode on which the insulating layer is formed is illustrated, wherein white particles are the black layer and gray particles are the first pattern electrode. According to the drawing, the line width of the first pattern electrode is uniformly formed of 1.51 to 1.77 μm.

FIG. 6B is a cross-sectional view of the first pattern electrode illustrated in FIG. 6A. Referring to FIG. 6B, the pattern electrode, the black layer, and the insulating layer are stacked sequentially.

Meanwhile, the second pattern electrode to electrically connect the first pattern electrode with an external power source may be formed on the transparent substrate. The second pattern electrode is formed at an edge of the transparent substrate, and the bezel portion of the touch screen panel is provided at a position where the second pattern electrode is formed. That is, the second pattern electrode is disposed in an area that is not visible to a user.

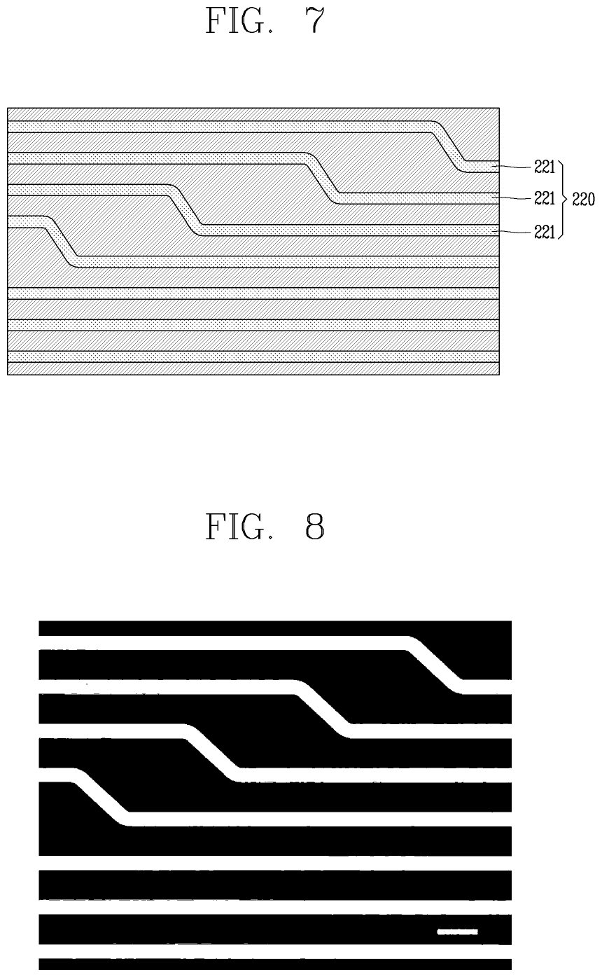

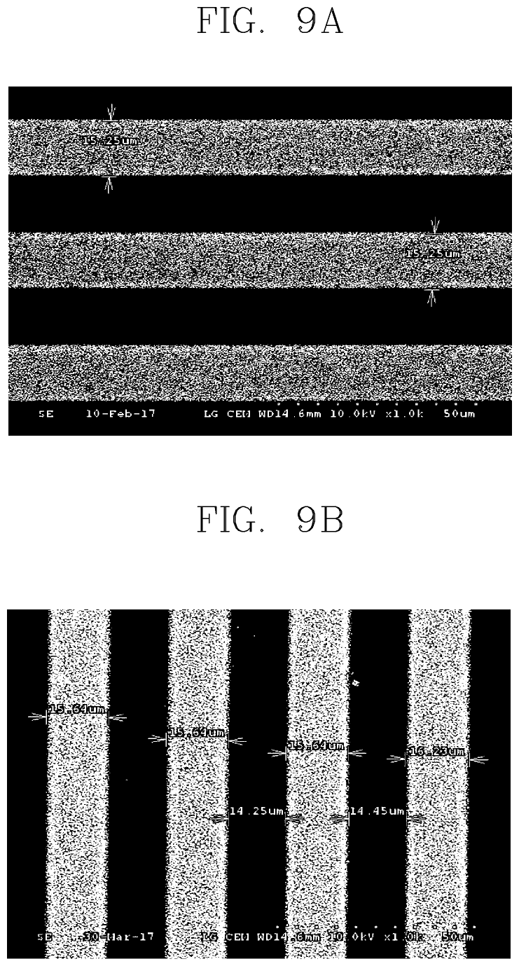

FIG. 7 is an enlarged view of an area B in FIG. 2, and FIGS. 8, 9A and 9B are SEM images of the electrode illustrated in FIG. 7.

Referring to FIG. 7, the second pattern electrode may include a plurality of line electrodes, and the line electrodes should not be electrically connected to each other. Therefore, the line electrodes should be spaced apart from each other by a specific distance. Here, as the distance between the line electrodes gets closer, the bezel portion of the touch screen panel may become thinner.

The line width of the second pattern electrode included in the touch screen panel according to the present disclosure may be of 10 to 15 μm. When the line width of the second pattern electrode is less than 10 μm, the sheet resistance may increase excessively, thereby excessively reducing the response speed of the touch screen panel. And, when the line width of the second pattern electrode exceeds 15 μm, the bezel portion of the touch screen panel may be excessively thick.

Meanwhile, a distance between the plurality of line electrodes constituting the second pattern electrode may be of 10 to 15 μm. When the distance between the line electrodes is less than 10 μm, a short may occur between the line electrodes, and when the distance between the line electrodes exceeds 15 μm, the bezel portion of the touch screen panel may be excessively thick.

As described above, the present disclosure includes the first pattern electrode overlapping the display and the second pattern electrode connecting the first pattern electrode with the external power source.

Referring to FIG. 8, the second pattern electrode includes the plurality of line electrodes.

Meanwhile, referring to FIGS. 9A and 9B, the plurality of line electrodes has a specific thickness and a specific distance therebetween.

The line width of the first pattern electrode formed on the touch screen panel according to the present disclosure is at least 1.5 times thinner than that of the related art technology, thereby minimizing the moire phenomenon occurring in the touch screen panel. Therefore, the present disclosure may improve visibility of the touch screen panel.

In addition, since a distance between electrodes and the line width of the second pattern electrode formed on the touch screen panel according to the present disclosure are very small as compared to the related art technology, a size of the bezel portion of the touch screen panel can be minimized.

On the other hand, a method of removing a remaining portion leaving only a specific pattern after depositing nano-particle ink on an entire substrate in order to form a pattern electrode was used in the related art. This method had a problem that a consumption of the nano-particle ink was very large, and the line width of the pattern electrode could not be reduced by a specific level or more.

In addition, since a process of forming the first pattern electrode and a process of the second pattern electrode were separated in the related art, forming the pattern electrode took a long time.

The present disclosure provides a method of manufacturing the touch screen panel which can minimize the consumption of the nano-particle ink and reduce the line width of the pattern electrode. In addition, the present disclosure provides a method of manufacturing the touch screen panel that can simultaneously form the above-described first and second pattern electrodes.

Hereinafter, a method of manufacturing the touch screen panel according to the present disclosure will be described.

First, forming a polymer layer on the transparent substrate is proceeded. Here, the polymer layer is a material whose surface tension is increased as irradiating light on it. For example, the polymer layer may be made of a fluorine-based polymer. On the other hand, the polymer layer is not limited to the fluorine-based polymer, but may be made of a material with a surface tension increased by irradiation with light and having a high light transmittance.

Subsequently, irradiating light of a predetermined wavelength after overlapping a glass mask with a predetermined pattern formed on the transparent substrate is proceeded.

Here, a surface tension of the polymer layer before irradiating light may be of 20 dynes or less, and the surface tension of the polymer layer after irradiating light may be of 32 dynes or more. When the surface tension of the polymer layer is more than 20 dynes before irradiating light, nano ink can be adhered even to an area where the light is not irradiated. Meanwhile, when the surface tension of the polymer layer is of 32 dynes or more after irradiating light, nano ink can be adhered with a high density.

Thereafter, applying silver nano-particle ink so that silver nano-particles are adhered to a partial area of the transparent substrate to which the light of the predetermined wavelength is irradiated is proceeded.

An average particle diameter of the nano-particles included in the silver nano-particle ink may be of 10 to 20 nm.

When the silver nano-particle ink is applied on the transparent substrate, it is selectively adhered only to an area to which light is irradiated. Here, a doctor blade may be utilized so that the silver nano-particles are evenly adhered to an entire area to which light is irradiated.

Thereafter, the silver nano-particles may be completely adhered to the transparent substrate by a heat treatment for 3 to 10 minutes at a temperature of about 140° C. Accordingly, the pattern electrode is formed on the transparent substrate.

Additionally, after applying at least one of carbon black, silver oxide, and silver chloride on the pattern electrode, forming the black layer by a heat treatment at a temperature of about 180° C. for 1 minute may be proceeded.

Meanwhile, forming an insulating layer by depositing at least one of acrylic, urethane, and alkyl thiol on the black layer may be proceeded.

As described above, since ink to form the pattern electrode may be selectively adhered on the transparent substrate according to the present disclosure, an amount of the ink may be minimized in forming the pattern electrode.

In addition, according to the present disclosure, since the first pattern electrode and the second pattern electrode may be formed simultaneously, a manufacturing process of the touch screen panel may be simplified.

It will be apparent to those skilled in the art that the present disclosure may be embodied in other specific forms without departing from the spirit or essential characteristics thereof.

Therefore, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

1. A touch screen panel comprising:
a transparent substrate;
a first pattern electrode formed on the transparent substrate and provided with a line width of 0.5 to 2.0 μm and a thickness of 0.1 to 1.0 μm; and
a second pattern electrode arranged on an edge of the transparent substrate so as to be electrically connected to the first pattern electrode, and provided with a line width of 10 to 15 μm,
wherein the first pattern electrode and the second pattern electrode comprise silver nano-particles having an average particle diameter of 10 to 20 nm.

2. The touch panel of claim 1, wherein a light transmittance of a partial area of the transparent substrate on which the first pattern electrode is formed is of 89.7 to 90.7%.

3. The touch panel of claim 1, wherein a sheet resistance of the first pattern electrode is of 100 to 336 Ω/sq.

4. The touch panel of claim 1, wherein the second pattern electrode comprises a plurality of line electrodes, and a distance between the line electrodes is of 10 to 15 μm.

5. The touch panel of claim 1, further comprising:
a black layer deposited on the first pattern electrode.

6. The touch panel of claim 5, wherein a thickness of the black layer is of 26. 8 to 53.2 nm.

7. The touch panel of claim 5, further comprising:
an insulating layer deposited on the black layer and made of a light-transmissive material.

8. The touch panel of claim 7, wherein a thickness of the insulating layer is of 73.7 to 146.3 nm.

9. A method for manufacturing a touch screen panel, the method comprising:
forming a fluorine-based polymer layer on a transparent substrate;
irradiating light of a predetermined wavelength after overlapping a glass mask with a predetermined pattern formed on the transparent substrate;
applying silver nano-particle ink so that silver nano-particles are adhered to a partial area of the transparent substrate to which a light of the predetermined wavelength is irradiated; and
heating the transparent substrate to form a first pattern electrode and a second pattern electrode on the transparent substrate.

10. The method of claim 9, wherein a surface tension of the fluorine-based polymer layer before irradiating the light of the predetermined wavelength is of 20 dynes or less, and the surface tension of the fluorine-based polymer layer after irradiating the light of the predetermined wavelength is of 32 dynes or more.
